(19) United States
(12) Patent Application Publication
(10) Pub. No.: US 2022/0188713 A1
(43) Pub. Date: Jun. 16, 2022

(54) CONTROLLED DEFERRALS OF MARKETING ACTION IN SEQUENTIAL WORKFLOWS

(71) Applicant: International Business Machines Corporation, Armonk, NY (US)

(72) Inventors: Herbert Scott McFaddin, Yorktown Heights, NY (US); Chandrasekhar Narayanaswami, Wilton, CT (US)

(21) Appl. No.: 17/118,763

(22) Filed: Dec. 11, 2020

(51) Int. Cl. G06Q 10/06; G06Q 30/02

(52) U.S. Cl. CPC G06Q 10/0633; G06Q 30/0201

(57) ABSTRACT

A computer system includes a memory having computer readable instructions and a processor for executing the computer readable instructions. The computer readable instructions control the processor to determine an active workflow initiated by a user. The active workflow includes a plurality of individual workflow stages that are sequentially presented to the user to complete a task. The processor further receives a user input requesting execution of a deferrable marketing action located at a current workflow stage of the active workflow, and controls the deferrable marketing action in response to the user input so as to delay execution of the deferrable marketing action.

### BACKGROUND

The present invention generally relates to programmable computing systems, and more specifically to computing systems, computer-implemented methods, and computer program products configured to control deferrals of marketing actions in sequential workflows.

Service or product providers often utilize web-based defined user workflows that automate a user-desired task. The workflows typically arrange a given task into a sequence of individual operations that step the user through the workflow to complete the task. Airline reservation websites, for example, employ workflows that guide a user through a sequence of ordered steps such as selection of dates, route designation, flight selection, seat selection and payment to complete the user's task, i.e., to book an airline flight. In another example, electronic commerce (E-commerce) websites employ workflows to guide users through a sequence of steps including product search, selected advertisement details, placement of a product in a cart, and shipping/payment submission to complete purchase of the product. Accordingly, service or product providers can use workflows to focus the user's attention on completing purchase of product or service, thereby improving the probability that a service or product is successfully purchased.

### SUMMARY

According to a non-limiting embodiment of the invention, a computer system includes a memory having computer readable instructions and a processor for executing the computer readable instructions. The computer readable instructions control the processor to determine an active workflow initiated by a user. The active workflow includes a plurality of individual workflow stages that are sequentially presented to the user to complete a task. The processor further receives a user input requesting execution of a deferrable marketing action located at a current workflow stage of the active workflow, and controls the deferrable marketing action in response to the user input so as to delay execution of the deferrable marketing action.

According to another non-limiting embodiment, a computer-implemented method is provided for controlling deferrals of marketing actions in a sequential workflow. The method comprises determining an active workflow initiated by a user. The active workflow includes a plurality of individual workflow stages that are sequentially presented to the user to complete a task. The method further comprises receiving a user input requesting execution of a deferrable marketing action located at a current workflow stage of the active workflow, and controlling the deferrable marketing action in response to the user input so as to delay execution of the deferrable marketing action.

According to yet another non-limiting embodiment, a computer program product is provided to control a computing system to control deferrals of marketing actions in a sequential workflow. The computer program product comprises a computer readable storage medium having program instructions embodied therewith. The program instructions are executable by an electronic computer processor to control the processor to perform operations comprising determining an active workflow initiated by a user. The active workflow includes a plurality of individual workflow stages that are sequentially presented to the user to complete a task. The method further comprises receiving a user input requesting execution of a deferrable marketing action located at a current workflow stage of the active workflow, and controlling the deferrable marketing action in response to the user input so as to delay execution of the deferrable marketing action

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a computing network configured to control deferrals of marketing actions in a sequential workflow according to a non-limiting embodiment of the invention;

FIG. 2 is a diagram of a service provider workflow that implements controlled deferrals of marketing actions according to a non-limiting embodiment of the invention;

FIG. 3 illustrates a user device displaying a first stage of a workflow providing a controlled deferral marketing action according to a non-limiting embodiment of the invention;

FIG. 4 illustrates the user device following user-interaction with the controlled deferred marketing action according to a non-limiting embodiment of the invention;

FIG. 5 illustrates the user device displaying a subsequent stage of the workflow and a deferred marketing action according to a non-limiting embodiment of the invention;

FIG. 6 illustrates the user device displaying the subsequent stage of the workflow and details of the deferred marketing action according to a non-limiting embodiment of the invention;

FIG. 7 is a flow diagram illustrating a method of controlling deferrals of marketing actions in a sequential workflow according to a non-limiting embodiment of the invention;

FIG. 8 illustrates a cloud computing environment according to a non-limiting embodiment of the invention;

FIG. 9 illustrates abstraction model layers included in a computing system according to a non-limiting embodiment of the invention; and

FIG. 10 illustrates a block diagram of a computer system for use in implementing one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

It is not uncommon for marketing actions, such as marketing advertisements (commonly referred to as “ads”), to be presented to users while the user moves through the individual steps of a service provider's workflow. At times, a user may decide to suspend activity with the workflow to view and interact with the advertisement. Although the service provider typically collects revenue when the user interacts with the advertisement, the service provider may prefer that the user maintain focus on the workflow until the task is completed (i.e., the service or product purchase is completed) to avoid losing potential revenue.

Various embodiments of the invention described herein provide a computing network configured to control deferrals of marketing actions (e.g., advertisement placements, user advertisement interaction, etc.) in a sequential workflow. The controlled deferral of marketing actions allows for executing advertisements (e.g., displaying advertisement details) to capture a user's interest in a product or service, but defers displaying the details of the advertised product and/or user interaction with the advertisement placement until a subsequent stage of the workflow. In this manner, the service provider can collect advertisement revenue, while still promoting the user's focus on completing the task (i.e., completing purchase of the service or product).

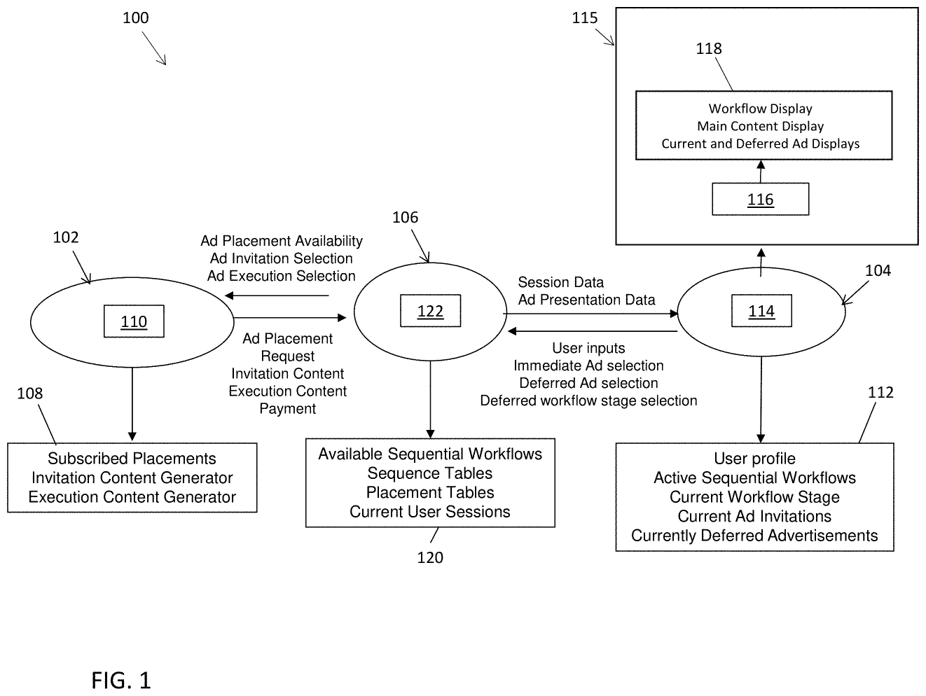

Turning now to FIG. 1, a computing network 100 configured to control deferrals of marketing actions in a sequential workflow is illustrated according to a non-limiting embodiment of the invention. The computing network 100 includes an advertiser system 102, a user system 104, and a service provider system 106. The service provider system 106 exchanges data with both the advertiser system 102 and the user system 104. The user system 104 can exchange data with one or more user devices 115 as described in greater detail below.

The advertiser system 102 includes an advertiser database 108 and an advertiser controller 110. The advertiser database 108 stores advertisement data including, but not limited to, available marketing actions (e.g., advertisement placements that can be subscribed to by the service provider system 106, subscribed advertisement placements that are subscribed to by the service provider system 106, invitation content that invites the service provider system 106 to subscribe to one or more of the available advertisement placements, and execution content.

The advertiser controller 110 is configured to exchange the advertisement data with the service provider system 106. In one or more non-limiting embodiments of the invention, the advertiser controller 110 is constructed as an electronic hardware controller that includes memory and a processor configured to execute algorithms and computer-readable program instructions stored in the memory. Accordingly, the advertiser controller 110 can send ad placement requests, ad content invitation requests, execution content, and payments to the service provider system 106. In addition, the advertiser controller 110 can receive from the service provider system 106 ad placement availability, ad invitation selections, and ad execution selections.

The user system 104 includes a user database 112 and a user controller 114. The user database 112 stores user information including, but not limited to, one or more user profiles, active sequential workflows, current workflow stages associated with a user participating in an active workflow, current executed as, and currently deferred ads. The user database 112 can further include a purchasing history of the user to detail each product purchased by the user within a given time frame, for example, a past number of years. In this manner, the user can be presented with advertisement placements catered to their preferences or interests.

The user controller 114 is configured to exchange data with the service provider system 106, the user database 112, and the user device 115. In one or more no-limiting embodiments of the invention, the user controller 114 is constructed as an electronic hardware controller that includes memory and a processor configured to execute algorithms and computer-readable program instructions stored in the memory. Accordingly, the user controller 114 can receive session data, webpage data, ad presentation data, and provide various user inputs to the service provider system 106 including, but not limited to, immediate ad selections, deferred ad selections, and deferred subsequent workflow stages at which to display details of a deferred ad.

The user device 115 can be constructed as various computing devices including, but not limited to, a desktop computer, laptop computer, tablet computer, smartphone, smart wearable device, or other smart devices known to one of ordinary skill in the art. The user device 115 includes a device controller 116 and a display 118. In one or more non-limiting embodiments of the invention, the display controller 116 is constructed as an electronic hardware controller that includes memory and a processor configured to execute algorithms and computer-readable program instructions stored in the memory. Accordingly, the display controller 116 can control the display 118 to display webpage data obtained from the service provider system 106, along with the user information obtained from the user database 112. For example, the user device 115 can display main content information associated with the service provider system 106 (e.g., the service provider's webpage), an active workflow initiated by the user, and ad placements included in the service provider's webpage. The ad placements include immediate ads and/or deferred ads, which are described in greater detail below.

The service provider system 106 includes a service provider database 120 and a service provider controller 122. The service provider database 120 can store webpage data for rendering a webpage associated with the service provider system 106, available sequential workflows available to automate a user-desired task, sequence tables, placement tables associated with advertisement placements, current user sessions, and received user marketing action inputs such as, for example, ad selection and deferred ad presentation workflow stages.

The service provider controller 122 is configured to provide the user system 104 with webpage data, session data, an active workflow initiated by the user, and marketing actions or advertisement placements to be included in the active workflow. In one or more non-limiting embodiments of the invention, the service provider controller 122 is constructed as an electronic hardware controller that includes memory and a processor configured to execute algorithms and computer-readable program instructions stored in the memory. Accordingly, the service provider controller 122 is capable controlling deferrals of marketing actions (e.g., advertisement execution, user advertisement interaction, advertisement detail presentation, etc.) in the active workflow. The controlled deferral of marketing actions or advertisement execution allows for displaying marketing actions (e.g., displaying advertisement placements) in given stage of an active workflow to capture a user's interest in a product or service, but defers or delays presenting the advertisement details and/or allowing full user interaction with the advertisement placement until a subsequent stage of the workflow. In this manner, the service provider system 106 can collected advertisement revenue, while still promoting the user's focus on completing the task (i.e., completing purchase of the service or product).

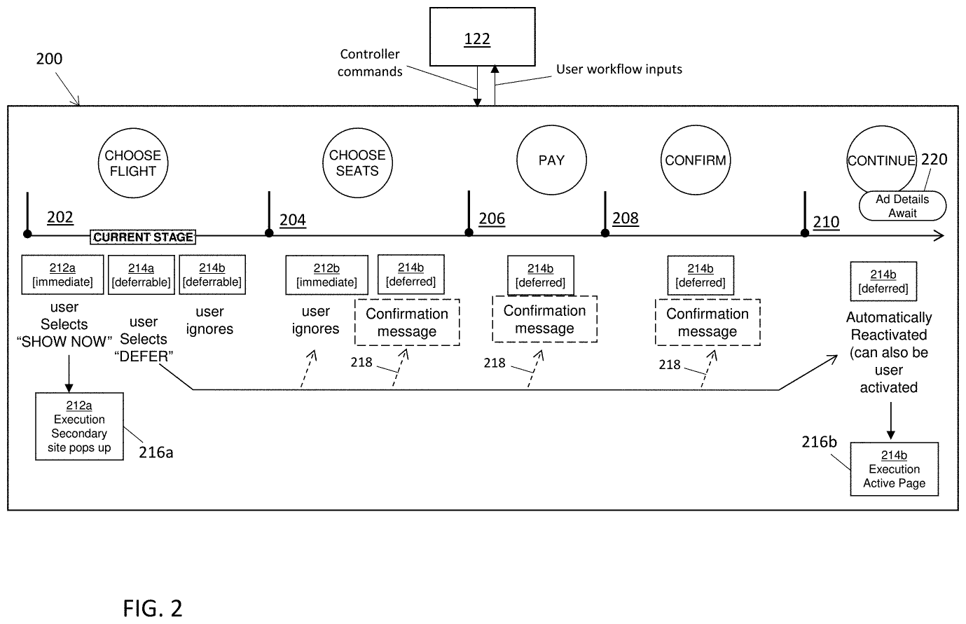

Referring to FIG. 2 and at times back to FIG. 1, an active workflow 200 generated by a controller 122 included in the service provider system 106 and displayed to a user operating the user device 115 is illustrated according to a non-limiting embodiment of the invention. The active workflow 200 includes a plurality of individual stages 202, 204, 206, 208 and 210 (collectively referred to as 202-210) that are sequentially presented to the user to complete a task. The task can include, for example, purchasing of a service or product provided by the service provider system 106. As one example, the task will be described in terms of purchasing an airline ticket. It should be appreciated, however, that sequential workflows associated with other tasks can be employed without departing from the scope of the invention.

In one or more non-limiting embodiments of the invention, the service provider system 106 generates the workflow 200. The workflow 200 can be generated in advance and stored in the service provider data base 120. When a user initiates a desired task (e.g., initiates the process to purchase an airline ticket), the service provider controller 122 can provide the user system 104 with the corresponding workflow 200, which is then displayed to the user via the user device 115.

When generating a given workflow 200, the service provider system 106 can set one or more immediate ad placements 212a and 212b, and one or more deferrable ad placements 214a and 214b (provided by the advertising system 102) at a given stage 202-210 of the workflow 200. Immediate ad placements 212 are marketing actions that execute immediately (either automatically or in response to a user input) without delay and in the current workflow stage at which the user is participating. For example, a user that selects (e.g., a mouse click) immediate ad placement 212a will invoke a pop-up window 216 that presents the user with the full details of product or service associated with the ad 212a in the current workflow stage (e.g., stage 202) at which the user is participating. In another example, the immediate ad placement 212a can automatically execute once the user is directed to the current workflow stage (e.g., stage 202) that contains the immediate ad placement 212a.

Deferrable ad placements 214a and 214b, on the other hand, can be controlled by the service provide controller 122 to present advertisement data differently than immediate ad placements 212a and 212b. For example, deferrable ad placements 214a and 214b do not execute immediately or in the current workflow stage at which they are placed. For instance, a user selection of deferrable ad 214a will not present details of the associated advertised product during current workflow stage 202. Instead, presentation of the full details associated with deferrable ad 214a will be delayed or deferred to stage 210.

In one or more non-limiting embodiments of the invention, the controller 122 can generate one or more confirmation messages 218, which are displayed on the user device 115. The confirmation message 218 is displayed at given stage of the workflow confirming that the deferrable ad placement 212a selected by the user can be executed at a particular subsequent stage of the workflow 200. The confirmation message 218 can be continuously displayed at each stage of the workflow 200 until the user reaches the stage at which the deferrable ad placement can be executed. In addition, the controller 122 can generate a deferred ad indicator 220 in the workflow 200 indicating the particular subsequent stage at which the deferred ad placement 212a can be executed.

Once the user reaches deferred subsequent stage (e.g., stage 210) and completes the task, the deferrable ad placement 214a can be executed. Accordingly, the full details of the deferrable ad placement 214a will be presented, e.g., displayed and/or read aloud in a pop-up screen 216b. In one or more non-limiting embodiments of the invention, deferrable ad placements (e.g., 212b) that are ignored by the user can be removed from subsequent stages of the active workflow 200 by the controller 122.

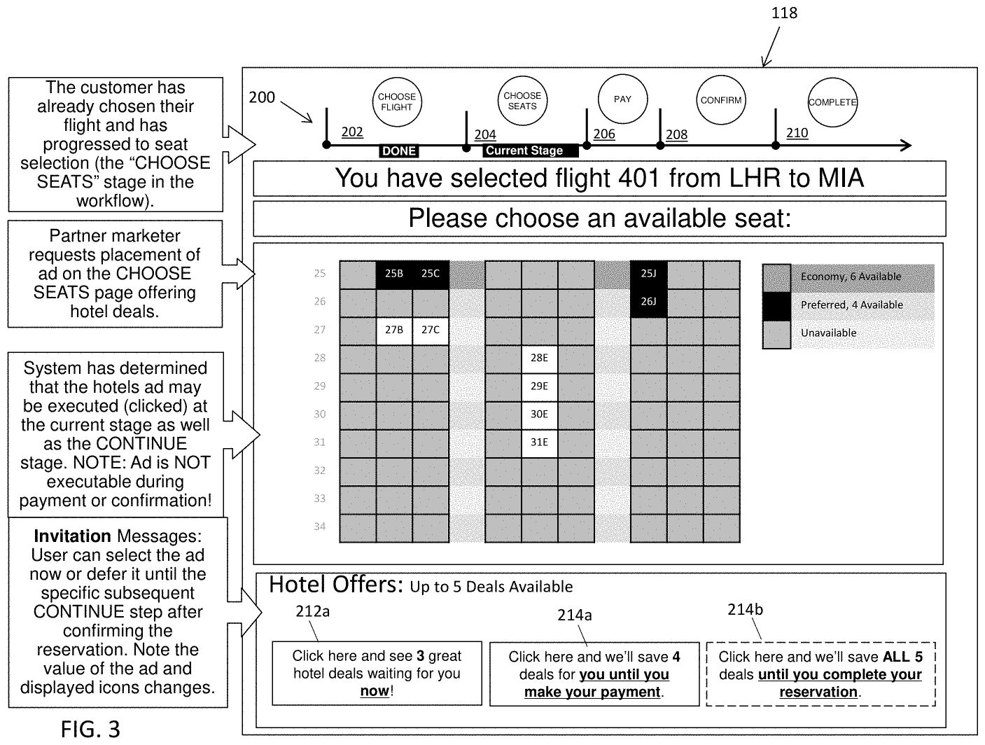

FIGS. 3-6 illustrate a user device display 118 displaying the controlled actions of a deferrable marketing action (e.g., a deferrable ad) based on an input provided by a user. At FIG. 3, for example, a service provider system can generate the active workflow 200 initiated by the user, determine the individual stages 202-210 of the active workflow 200, and track the current workflow stage of the user as they progress through the active workflow 200. When generating the workflow 200, the service provider system can place one or more immediate marketing actions 212a (e.g., immediate ads) and/or one or more deferrable marketing actions 214a, 214b (e.g., deferrable ads) in a given stage of the workflow 200 (e.g., stage 204). The service provider system determines the remaining subsequent workflow stages 206, 208 and 210 at which to defer or delay execution of the deferrable ads 214a, 214b (e.g., display the full details of the advertisement). The immediate ad 212a can present the user with the full details of the advertised service or product in the current workflow stage. The deferrable ads 214a, 214b, however, can defer presentation of the full details of the service or product until a subsequent workflow stage, e.g., stage 206 or stage 210, respectively. In this example, a user's selection of deferrable ad 214b is indicated by the dashed indictor box.

In one or more non-limiting embodiments of the invention, the controlled deferral of ads 214a and 214b includes displaying different details of the advertised service or product based on the subsequent stage selected by the user. For example, a first number of services or product deals can be offered to the user at the earlier subsequent workflow stage 206, while a greater number of services or product deals can be offered to the user at the later subsequent workflow stage 110.

In another example, first product details having a first value can be presented to the user in response to the user's selection of a first subsequent stage, e.g., stage 206, while different product details providing a different value can be presented to the user in response to the user's selection to execute the deferred ad placement in a later subsequent stage (e.g., stage 210) located downstream from the first subsequent stage. The value can include for example, a purchasing price. Accordingly, the purchasing price of a given product or service displayed at the later subsequent workflow stage 210 can be less than the purchasing price of the given product or service displayed at the earlier subsequent workflow stage 206. In yet another example, the value includes, for example, a monetary value. Accordingly, a base-line service/product monetary value of a first given product or service can be presented to the user at the earlier subsequent workflow stage, while luxury services or products can be presented at the later subsequent selected workflow stage 210.

In any of the examples described, the user is provided greater value or a greater incentive to complete the task associated with the active workflow 200 (e.g., complete purchase of the airline ticket). Accordingly, the service provider reduces the risk that the user will become distracted and fail to complete the purchasing transaction, while still collecting advertising revenue from the advertiser.

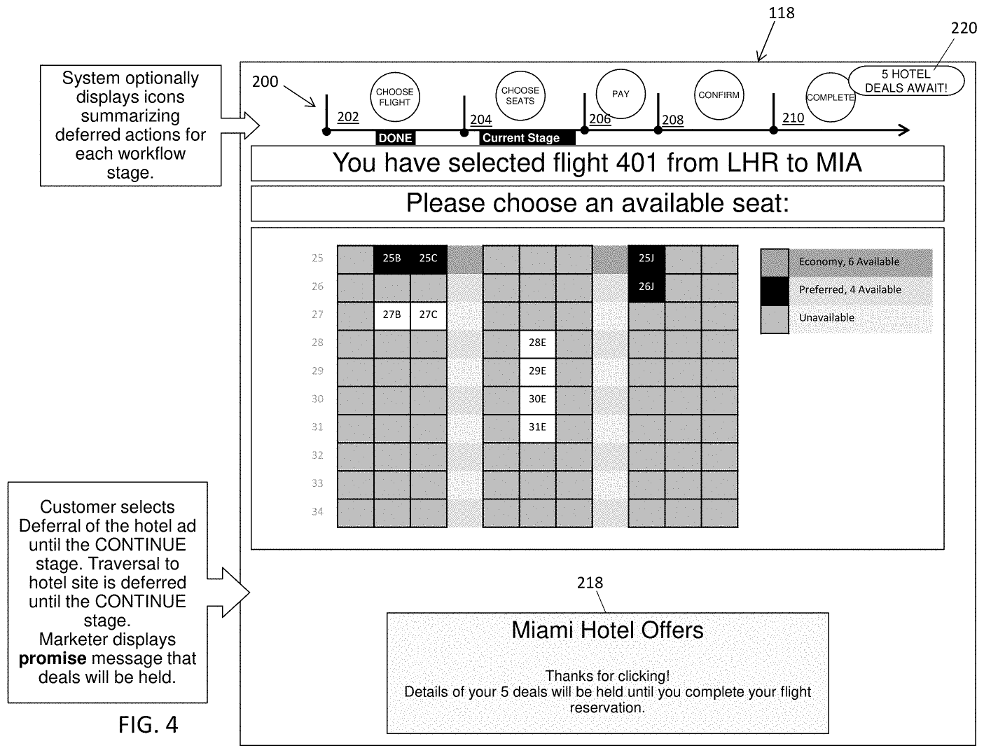

Turning to FIG. 4, the user device display 118 is illustrated following the user's selection to defer execution of ad placement 212b until after completing the task (e.g., after completing purchase of the airline ticket). In exchange for maximizing deferment of the advertisement execution, the service provider generates a confirmation message 218, which informs the user that five advertisement offers are awaiting execution following completion of the task at stage 210. In addition a deferred ad indicator 220 is displayed at stage 210 indicating the deferment of five ads.

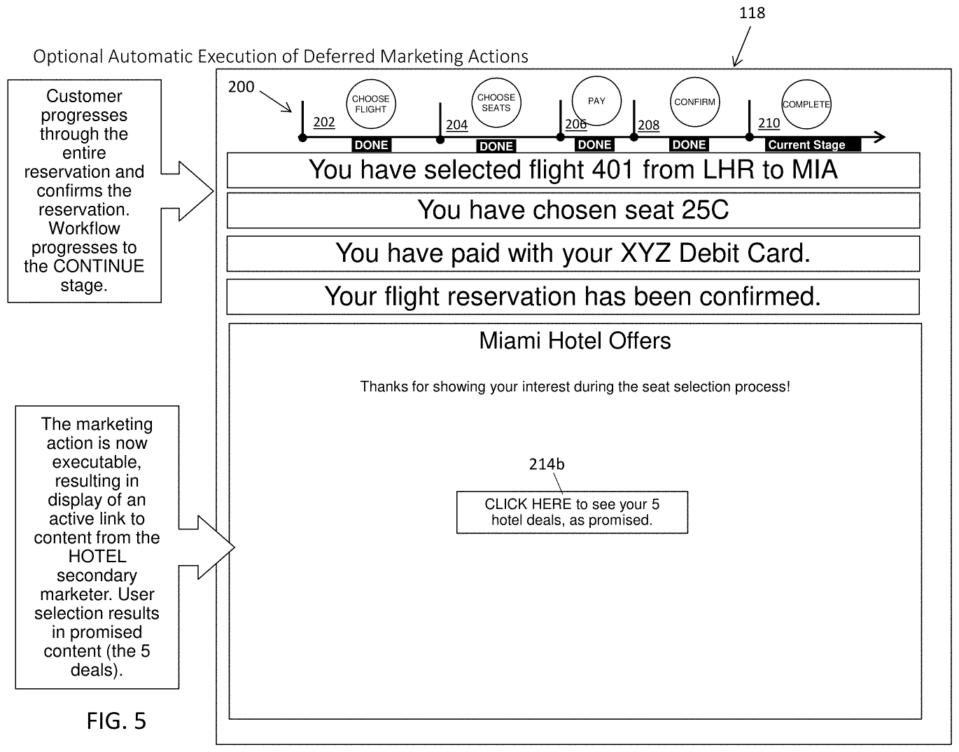

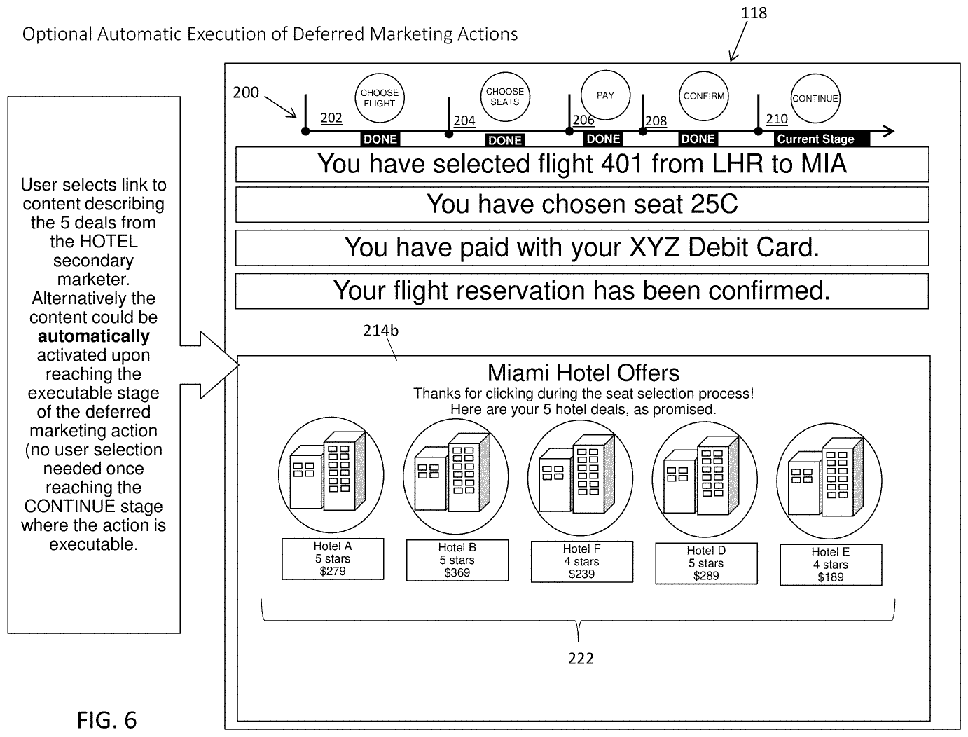

Referring to FIG. 5, the user has progressed through the active workflow 200 and has completed that task at stage 210, e.g., completed purchasing the airline ticket. Accordingly, the deferred ad placement 214b prompts the user to execute the deferred ad placement 214b. At FIG. 6, the display 118 is illustrated following execution of the deferred ad placement 214b, and full details 222 of the service or product are presented to the user. Accordingly, the service provider is able to collect advertisement revenue by presenting the product advertisement in the active workflow 200, while still promoting the user's focus on completing the task (i.e., completing purchase of the service or product).

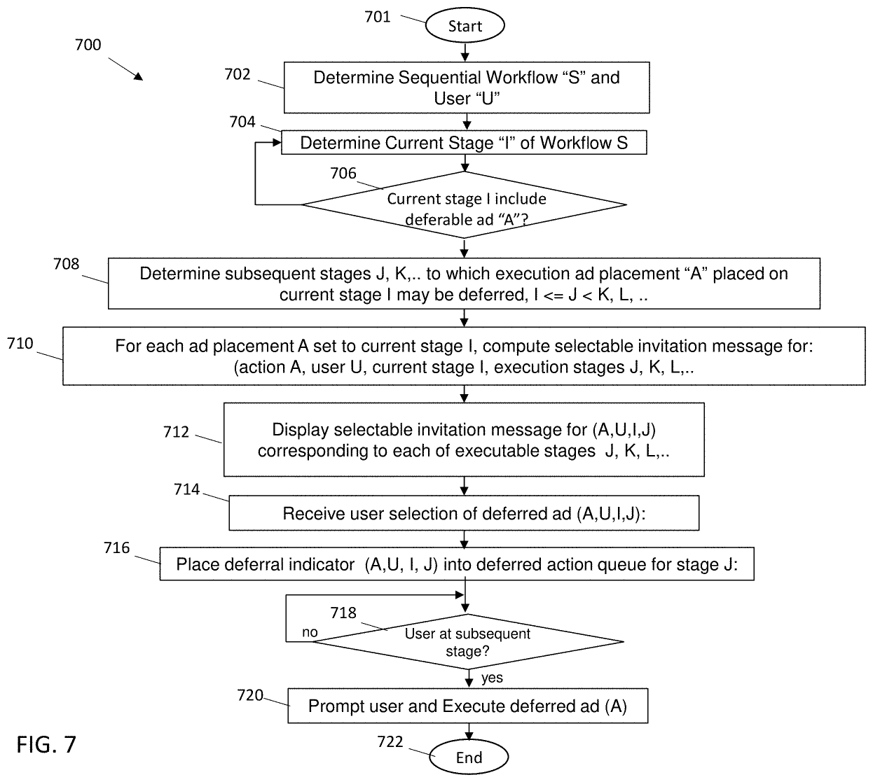

With reference now to FIG. 7, a computer-implemented method 700 configured and arranged to control deferrals of marketing actions in a sequential workflow is illustrated according to a non-limiting embodiment of the invention. In accordance with embodiments of the invention, the method 700 is implemented by a controller and instruction configured to control the controller to perform operations described herein. The method 700 starts at operation 701, and at operation 702 at sequential workflow (S), a user (U), and an activated workflow (S) are determined. At operation 704, a current workflow stage (I) at which the user is present in the workflow is determined. At operation 706, a determination is made as to whether the current workflow stage includes a deferrable ad placement (A). When no deferrable ad placements are included in the current workflow stage, the method 700 returns to operation 704 and continues to determine the user's current workflow stage. When, however, a deferrable ad placement is included in the current workflow stage, the method 700 proceeds to operation 708 and determines one or more available subsequent workflow stages (J, K, etc.) located downstream from the current workflow stage (I) at which to execute the deferrable ad placement are determined. At operation 710, text is generated inviting the user to defer the execution of the ad placement to a subsequent workflow stage. The text includes informing the user of different values of the advertised product associated with the deferred ad placement based on the subsequent stage at which to execute the deferred ad placement.

At operation 712, the generated text is added to each deferred ad placement and displayed on the user device, and at operation 714 one or more user inputs selecting one or more deferred ad placements are received. At operation 716, a deferral indicator is displayed on the active workflow indicating one or more subsequent stages contained a respective deferred ad placement. At operation 718, a determination is made as to whether the user has reached the subsequent stage in the workflow that contains a user-selected deferred ad placement. When the user has not reached the subsequent stage, the method 700 returns to operation 718 and continues monitoring the user's progress through the workflow. When, however, the user has reached the subsequent stage containing a user-selected deferred ad placement, the user is prompted to execute the deferred ad placement at operation 720. In response to receiving the user's input, the deferred ad placement is executed, details of the advertised service and/or product are presented to the user, and the method 700 ends at operation 722.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

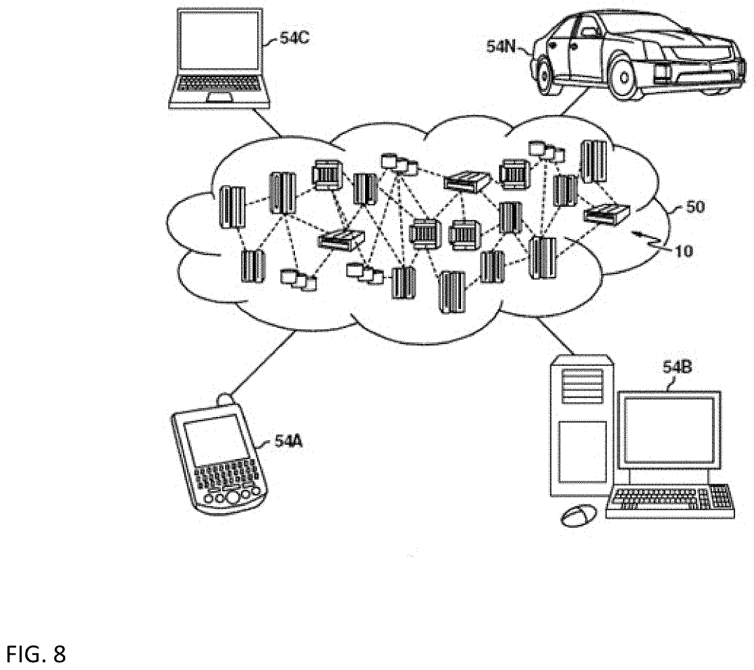

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

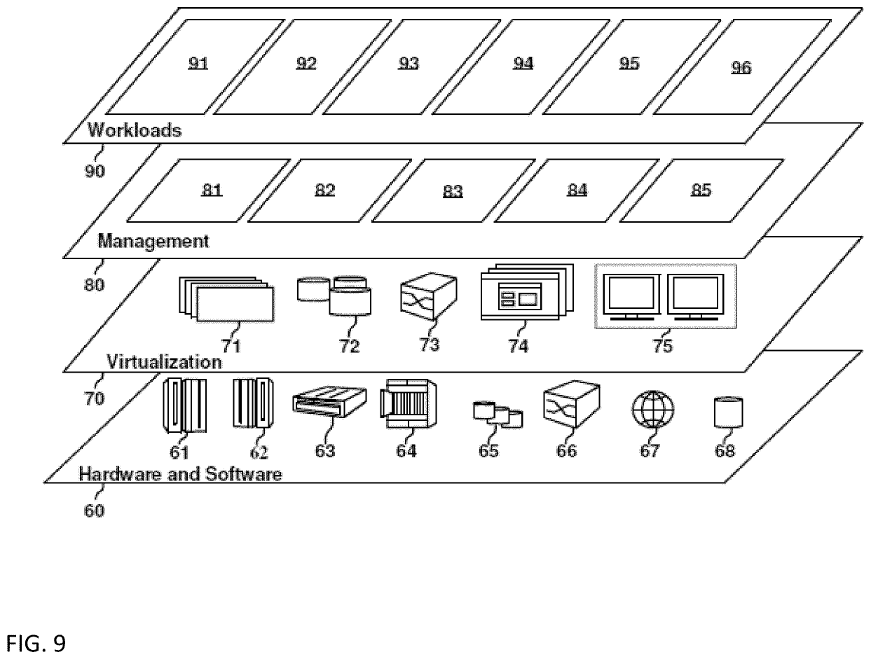

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments of the invention, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and product recommendation 96.

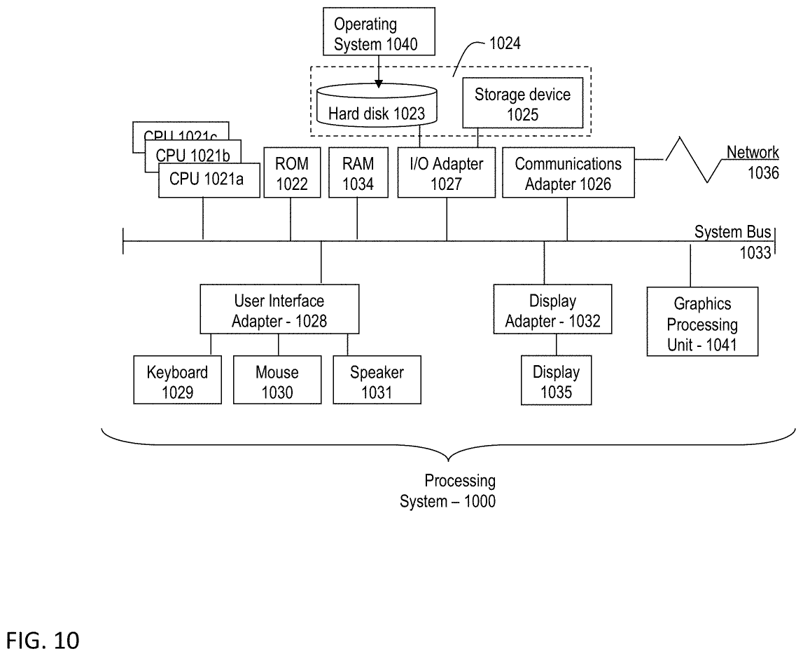

It is understood that the present disclosure is capable of being implemented in conjunction with any other type of computing environment now known or later developed. For example, FIG. 10 depicts a block diagram of a processing system 1000 for implementing the techniques described herein. In examples, the processing system 1000 has one or more central processing units (processors) 1021a, 1021b, 1021c, etc. (collectively or generically referred to as processor(s) 1021 and/or as processing device(s)). In aspects of the present disclosure, each processor 1021 can include a reduced instruction set computer (RISC) microprocessor. Processors 1021 are coupled to system memory 1024, read-only memory (ROM) 1022, random access memory (RAM) 1034, and various other components via a system bus 1033. The ROM 1022 is coupled to system bus 1033 and can include a basic input/output system (BIOS), which controls certain basic functions of the processing system 1000. The RAM 1034 is coupled to the system bus 103 and can be read and changed in any order, typically used to store working data and machine code.

Further depicted are an input/output (I/O) adapter 1027 and a network communications adapter 1026 coupled to the system bus 1033. I/O adapter 1027 can be a small computer system interface (SCSI) adapter that communicates with a hard disk 1023 and/or a storage device 1025 such as a tape unit, mobile memory device, or any other similar component. I/O adapter 1027, hard disk 1023, and storage device 1025 are collectively referred to herein as mass storage 1024. Operating system 1040 for execution on processing system 1000 can be stored in mass storage 1024. The network adapter 1026 interconnects system bus 1033 with an outside network 1036 enabling processing system 1000 to communicate with other such systems.

A display (e.g., a display monitor) 1035 is connected to the system bus 1033 by display adapter 1032, which can include a graphics adapter to improve the performance of graphics intensive applications and a video controller. In one aspect of the present disclosure, adapters 1026, 1027, and/or 1032 can be connected to one or more I/O busses that are connected to the system bus 1033 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1033 via user interface adapter 1028 and display adapter 1032. An input device (e.g., a keyboard 1029, a microphone, a touchscreen, etc.), an input pointer 1030 (e.g., a mouse, trackpad, touchscreen, etc.), and/or a speaker 1031 can be interconnected to system bus 1033 via user interface adapter 1028, which can include, for example, a Super I/O chip integrating multiple device adapters into a single integrated circuit.

In some aspects of the present disclosure, the processing system 1000 includes a graphics processing unit 1041. Graphics processing unit 1041 is a specialized electronic circuit designed to manipulate and alter memory to accelerate the creation of images in a frame buffer intended for output to a display. In general, graphics processing unit 1041 is very efficient at manipulating computer graphics and image processing and has a highly parallel structure that makes it more effective than general-purpose CPUs for algorithms where processing of large blocks of data is done in parallel.

Thus, as configured herein, the processing system 1000 includes processing capability in the form of processors 1021, storage capability including system memory (e.g., RAM 1034), input means such as keyboard 1029 and mouse 1030, and output capability including speaker 1031 and display 1035. In some aspects of the present disclosure, a portion of system memory (e.g., RAM 1034) and mass storage 1024 collectively store the operating system 1040 to coordinate the functions of the various components shown in the processing system 1000.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments of the invention, various functions or acts can take place at a given location and/or in connection with the operation of one or more apparatuses or systems. In some embodiments of the invention, a portion of a given function or act can be performed at a first device or location, and the remainder of the function or act can be performed at one or more additional devices or locations.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments of the invention were chosen and described in order to best explain the principles of the disclosure and the practical application, and to enable others of ordinary skill in the art to understand the disclosure for various embodiments of the invention with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments of the invention, electronic circuitry including, for example, programmable logic circuitry, field-programmable gate arrays (FPGA), or programmable logic arrays (PLA) can execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer system comprising:
a memory having computer readable instructions; and
a processor for executing the computer readable instructions, the computer readable instructions controlling the processors to perform operations comprising:
determining an active workflow initiated by a user, the active workflow including a plurality of individual workflow stages that are sequentially presented to the user to complete a task;
receiving a user input requesting execution of a deferrable marketing action located at a current workflow stage of the active workflow; and
controlling the deferrable marketing action in response to the user input so as to delay execution of the deferrable marketing action,
wherein delaying the execution comprises:
sending the user an invitation to select a desired subsequent workflow stage following the current workflow stage at which to receive details of an advertisement associated with the deferrable marketing action;
receiving a user input indicating the selected desired subsequent workflow stage; and
delaying the execution of the marketing action until the user reaches the selected desired subsequent workflow stage.

2. (canceled)

3. (canceled)

4. The computer system of claim 31, wherein controlling the deferrable marketing action includes displaying first advertisement details having a first value in response to receiving from the user a first selected desired subsequent workflow stage and displaying second advertisement details having a second value greater than the first value in response to receiving from the user a second selected desired subsequent workflow stage located downstream from the first selected desired workflow stage.

5. The computer system of claim 31, wherein controlling the deferrable marketing action includes displaying a confirmation message at the current workflow stage of the workflow indicating an awaiting deferrable marketing action at the selected desired subsequent workflow stage.

6. The computer system of claim 5, wherein the confirmation message is continuously displayed at each subsequent workflow stage of the workflow following the current work flow stage until the user reaches the selected desired subsequent workflow stage.

7. The computer system of claim 1, wherein the current workflow stage includes an immediate marketing action, and wherein the processor executes the immediate marketing action in the current workflow stage.

8. A computer-implemented method for controlling deferrals of marketing actions in a sequential workflow, the method comprising:
determining an active workflow initiated by a user, the active workflow including a plurality of individual workflow stages that are sequentially presented to the user to complete a task;
receiving a user input requesting execution of a deferrable marketing action located at a current workflow stage of the active workflow; and
controlling the deferrable marketing action in response to the user input so as to delay execution of the deferrable marketing action,
wherein delaying the execution comprises:
sending the user an invitation to select a desired subsequent workflow stage following the current workflow stage at which to receive details of an advertisement associated with the deferrable marketing action;
receiving a user input indicating the selected desired subsequent workflow stage; and
delaying the execution of the marketing action until the user reaches the selected desired subsequent workflow stage.

9. (canceled)

10. (canceled)

11. The method of claim 8, wherein controlling the deferrable marketing action includes displaying first advertisement details having a first value in response to receiving from the user a first selected desired subsequent workflow stage and displaying second advertisement details having a second value greater than the first value in response to receiving from the user a second selected desired subsequent workflow stage located downstream from the first selected desired workflow stage.

12. The method of claim 8, wherein controlling the deferrable marketing action includes displaying a confirmation message at the current workflow stage of the workflow indicating an awaiting deferrable marketing action at the selected desired subsequent workflow stage.

13. The method of claim 12, wherein the confirmation message is continuously displayed at each subsequent workflow stage of the workflow following the current work flow stage until the user reaches the selected desired subsequent workflow stage.

14. The method of claim 8, wherein the current workflow stage includes an immediate marketing action, and wherein the processor executes the immediate marketing action in the current workflow stage.

15. A computer program product to control a computing system to control deferrals of marketing actions in a sequential workflow, the computer program product comprising a computer readable storage medium having program instructions embodied therewith, the program instructions executable by an electronic computer processor to control the processor to perform operations comprising:
determining an active workflow initiated by a user, the active workflow including a plurality of individual workflow stages that are sequentially presented to the user to complete a task;
receiving a user input requesting execution of a deferrable marketing action located at a current workflow stage of the active workflow; and
controlling the deferrable marketing action in response to the user input so as to delay execution of the deferrable marketing action
wherein delaying the execution comprises:
sending the user an invitation to select a desired subsequent workflow stage following the current workflow stage at which to receive details of an advertisement associated with the deferrable marketing action;
receiving a user input indicating the selected desired subsequent workflow stage; and
delaying the execution of the marketing action until the user reaches the selected desired subsequent workflow stage.

16. (canceled)

17. (canceled)

18. The computer program product of claim 15, wherein controlling the deferrable marketing action includes displaying first advertisement details having a first value in response to receiving from the user a first selected desired subsequent workflow stage and displaying second advertisement details having a second value greater than the first value in response to receiving from the user a second selected desired subsequent workflow stage located downstream from the first selected desired workflow stage.

19. The computer program product of claim 15, wherein controlling the deferrable marketing action includes displaying a confirmation message at the current workflow stage of the workflow indicating an awaiting deferrable marketing action at the selected desired subsequent workflow stage.

20. The computer program product of claim 19, wherein the confirmation message is continuously displayed at each subsequent workflow stage of the workflow following the current work flow stage until the user reaches the selected desired subsequent workflow stage.
